(19) United States
(12) Patent Application Publication
(10) Pub. No.: US 2024/0088988 A1
(43) Pub. Date: Mar. 14, 2024

(54) MEDIUM ACCESS CONTROL PROTOCOL DATA UNIT FORWARDING

(71) Applicant: Nokia Technologies OY, Espoo (FI)

(72) Inventor: Zhijie YANG, Espoo (FI)

(73) Assignee: Nokia Technologies OY, Espoo (FI)

(21) Appl. No.: 18/261,860

(22) PCT Filed: Jan. 19, 2021
(86) PCT No.: PCT/CN2021/072756

§ 371 Date: Jul. 18, 2023

(51) Int. Cl. H04B 7/155; H04W 74/08

(52) U.S. Cl. CPC H04B 7/15507; H04W 74/0808; H04W 88/08

(57) ABSTRACT

Embodiments of the present disclosure relate to device, method, apparatus and computer readable storage medium of MPDU forwarding in a VBSS based mesh network. The method comprises receiving, at a first device, a first data unit from a second device in a first TXOP allocated by the second device for data transmission between the first device and the second device, the first data unit having a header comprising an identifier of the first device; de-aggregating the first data unit into a plurality of sub-data units; and processing the plurality of sub-data units based on respective address information associated with the plurality of sub-data units. In this way, the converting the MAC header of MPDUs between backhaul and fronthaul and decryption and encryption of the data unit can be avoided, which improves the efficiency of data forwarding. Meanwhile, the interference between backhaul and fronthaul working on the same channel can be eliminated and the TP of whole link can be increased.

### FIELD

Embodiments of the present disclosure generally relate to the field of telecommunication and in particular, to device, method, apparatus and computer readable storage medium of Medium Access Control Protocol Data Unit (MPDU) forwarding.

### BACKGROUND

In a mesh network, when a Station (STA) accesses the Internet through an extender Access Point (AP), the uplink (UL) traffics sent from the STA to a the root AP may need to be parsed by the Wi-Fi protocol stack of the extender AP when these UL traffics are delivered via fronthaul. At the extender AP, the UL traffics can be reassembled into new Physical Layer Protocol Data Units (PPDUs) after changing the MPDU header (i.e. switching a fronthaul MAC header to be a backhaul MAC header) and then forwarded to the root AP via backhaul. Finally, the UL traffics from the STA can be sent to the Internet via the root AP.

Similarly, for the Downlink (DL) traffics sent from the root AP to STA, the DL traffics may also need to be parsed by the Wi-Fi protocol stack of the extender AP when the DL traffics are delivered via backhaul. The DL traffics can be reassembled into new PPDU after changing the MPDU header (i.e. switching the backhaul MAC header to be a fronthaul MAC header) at the extender AP and then are sent to STA via fronthaul. The above mentioned forwarding mechanism belongs to Medium Access Control Service Data Unit (MSDU) forwarding.

### SUMMARY

In general, example embodiments of the present disclosure provide a solution of MPDU forwarding in a Virtual Basic Service Set (VBSS) based mesh network.

In a first aspect, there is provided a first device. The first device comprises at least one processor; and at least one memory including computer program codes; the at least one memory and the computer program codes are configured to, with the at least one processor, cause the first device at least to receive a first data unit from a second device in a first transmission opportunity (TXOP) allocated by the second device for data transmission between the first device and the second device, the first data unit having a header comprising an identifier of the first device; de-aggregate the first data unit into a plurality of sub-data units; and process the plurality of sub-data units based on respective address information associated with the plurality of sub-data units.

In a second aspect, there is provided a second device. The second device comprises at least one processor; and at least one memory including computer program codes; the at least one memory and the computer program codes are configured to, with the at least one processor, cause the second device at least to aggregate a plurality of sub-data units into a first data unit, the first data unit having a header comprising an identifier of a first device; obtain a first TXOP allocated by the second device for data transmission between the first device and the second device; and transmit the first data unit to the first device in the first TXOP.

In a third aspect, there is provided a method. The method comprises receiving, at a first device, a first data unit from a second device in a first TXOP allocated by the second device for data transmission between the first device and the second device, the first data unit having a header comprising an identifier of the first device; de-aggregating the first data unit into a plurality of sub-data units; and processing the plurality of sub-data units based on respective address information associated with the plurality of sub-data units.

In some example embodiments, processing the plurality of sub-data units comprises in accordance with a determination, based on the respective address information, that a set of sub-data units in the plurality of sub-data units are to be transmitted to a third device, re-aggregating the set of sub-data units into a second data unit; and forwarding the second data unit to the third device in a second TXOP allocated by the second device for a data transmission between the first device and the third device.

In some example embodiments, the method further comprises in accordance with a determination that an acknowledgement is received, the acknowledgement indicating that the second data unit has been received by the third device is received, removing the set of sub-data units.

In some example embodiments, the method further comprises in accordance with a determination that the acknowledgement is required by the second device, forwarding the acknowledgement to the second device in the first TXOP allocated by the second device for data transmission between the first device and the second device.

In some example embodiments, the method further comprises in accordance with a determination that a roaming occurred at the third device based on the acknowledgement received from the third device, generating a roaming request to indicating a roaming event of the third device; and transmitting the roaming request together with the acknowledgement to the second device.

In some example embodiments, the method further comprises in accordance with a determination, based on the respective address information, that a further set of sub-data units in the plurality of sub-data units are to be transmitted to the first device, transmitting, to the second device in the first TXOP allocated by the second device for data transmission between the first device and the second device, an acknowledgement indicating that the further set of sub-data units have been received by the first device.

In some example embodiments, the method further comprises in accordance with a determination that a third data unit received from the third device is to be transmitted to the second device, transmitting, to the second device in a third TXOP allocated by the second device for further data transmission between the first device and the second device, a buffer status report indicating the third data unit is to be transmitted from the third device to the second device and an acknowledgement associated with third data unit transmitted from the first device to the third device; and in accordance with a determination that the third data unit is expected to be received by the second device based on a trigger received from the second device, forwarding the fourth data to the second device in the third TXOP.

In a fourth aspect, there is provided a method. The method comprises aggregating, at a second device, a plurality of sub-data units into a first data unit, the first data unit having a header comprising an identifier of a first device; obtaining a first TXOP allocated by the second device for data transmission between a first device and the second device; and transmitting the first data unit to the first device in the first TXOP allocated by the second device for data transmission between the first device and the second device.

In some example embodiments, if the plurality of sub-data units comprises a set of sub-data units to be transmitted to a third device, the method further comprises transmitting, to the first device in the first TXOP allocated by the second device for data transmission between the first device and the second device, a request for an acknowledgement indicating that the set of sub-data units have been received by the third device.

In some example embodiments, if the plurality of sub-data units comprises a further set of sub-data units to be transmitted to a first device, the method further comprises receiving, from the first device in the first TXOP allocated by the second device for data transmission between the first device and the second device, an acknowledgement indicating that the further set of sub-data units have been received by the first device.

In some example embodiments, the method further comprises in accordance with a determination that a roaming request indicating a roaming event of the third device is received together with the acknowledgement for set of sub-data units, allocating a fourth device to the third device for a subsequent data transmission from the second device to the third device.

In some example embodiments, the method further comprises in accordance with a determination that a buffer status report is received from the first device in a third TXOP allocated by the second device for further data transmission between the first device and the second device, the buffer status report indicating the third data unit is to be transmitted from a third device to the second device and an acknowledgement associated with third data unit transmitted from the first device to the third device, determining whether the third data unit is expected to be received by the second device; in accordance with a determination that the third data unit is expected to be received, generating a trigger for the first device to forward the third data unit to the second device; and transmitting the trigger to the first device in the third TXOP.

In a fifth aspect, there is provided an apparatus comprises means for receiving, at a first device, a first data unit from a second device in a first TXOP allocated by the second device for data transmission between the first device and the second device, the first data unit having a header comprising an identifier of the first device; means for de-aggregating the first data unit into a plurality of sub-data units; and means for processing the plurality of sub-data units based on respective address information associated with the plurality of sub-data units.

In a sixth aspect, there is provided an apparatus comprises means for aggregating, at a second device, a plurality of sub-data units into a first data unit, the first data unit having a header comprising an identifier of a first device; means for obtaining a first TXOP allocated by the second device for data transmission between a first device and the second device; and means for transmitting the first data unit to the first device in the first TXOP.

In a seventh aspect, there is provided a computer readable medium having a computer program stored thereon which, when executed by at least one processor of a device, causes the device to carry out the method according to the third aspect.

In an eighth aspect, there is provided a computer readable medium having a computer program stored thereon which, when executed by at least one processor of a device, causes the device to carry out the method according to the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 illustrates a signaling chart demonstrating an example process of MPDU forwarding in a VBSS based mesh network according to some embodiments of the present disclosure;

FIGS. 3A-3B shows examples of the data structure in the process of MPDU forwarding according to some embodiments of the present disclosure;

FIGS. 4A-4D show examples of time sequence for data transmission in the process of MPDU forwarding according to some embodiments of the present disclosure;

FIG. 5 shows a flowchart of an example method of MPDU forwarding in a VBSS based mesh network according to some example embodiments of the present disclosure;

FIG. 6 shows a flowchart of an example method of MPDU forwarding in a VBSS based mesh network according to some example embodiments of the present disclosure;

FIG. 7 shows a simplified block diagram of a device that is suitable for implementing example embodiments of the present disclosure; and

FIG. 8 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Wi-Fi, fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, Wi-Fi1-Wi-Fi7 and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio head (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

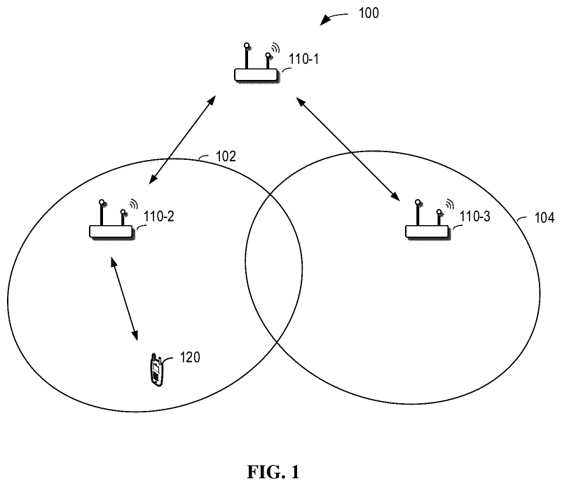

FIG. 1 shows an example communication network 100 in which embodiments of the present disclosure can be implemented. As shown in FIG. 1, the communication network 100 comprises multiple APs 110-1, 110-2 and 110-3. In the communication network 100, the AP 110-1 may be considered as a root AP (hereinafter also referred to as a second device 120-1) and the APs 110-2 and 110-3 may be considered as extender APs (hereinafter the AP 110-2 may also be referred to as a first device 110-2 and the AP 110-3 may also be referred to as a fourth device 110-3.) The extender APs 110-2 and 110-3 can communicate with the root AP 110-1.

Furthermore, the communication network 100 may also comprise a terminal device 120 (hereinafter may also be referred to as a third device 120 or a STA 120.) When the STA 120 is located in the coverage 102 of the extender AP 110-2, the STA 120 can communicate with the extender AP 110-2. When the STA 120 moves to the coverage 104 of the extender AP 110-3 in the roaming process, the STA 120 can communicate with the extender AP 110-3. It is to be understood that the number of APs and terminal devices shown in FIG. 1 is given for the purpose of illustration without suggesting any limitations. The communication network 100 may include any suitable number of APs and terminal devices.

As mentioned above, the MSDU forwarding mechanism has been specified. In this mechanism, the STA 120 can access the Internet through an extender AP (for example, the extender AP 110-2 shown in FIG. 1.) In the UL communication, the UL traffics sent from the STA 120 to the root AP 110-1 may need to be parsed by the Wi-Fi protocol stack of the extender AP 110-2 when these UL traffics are delivered via fronthaul. At the extender AP 110-2, the UL traffics can be reassembled into new PPDUs after changing the MPDU header and then forwarded to the root AP 110-1 via backhaul. Finally, the UL traffics from the STA 120 can be sent to the Internet via the root AP 110-1. Similarly, in the DL communication, the DL traffics sent from the root AP 110-1 to the STA 120 may also need to be parsed by the Wi-Fi protocol stack of the extender AP 110-2 when the DL traffics are delivered via backhaul. The DL traffics can be reassembled into new PPDU after changing the MPDU header at the extender AP 110-2 and then are sent to STA 120 via fronthaul.

However, the link throughput (TP) drop may be caused by possible Block Ack (BA) jitter problems in the backhaul link or fronthaul link, i.e. frequently add BA and delete BA interactions on the backhaul or fronthaul link. Therefore, in a case where the data unit transmitted by the root AP reaches the STA after two jumps (for example, the MSDU forwarding), the issue of TP drop may be exacerbated.

Further, in a roaming or load balance scenario, in order to ensure the continuity and integrity of the MPDUs received by STA, the buffered data frames for the roaming STA needs to be transferred from the current anchor AP (an extender AP) to the target anchor AP (a further extender the extender AP 110-3) via root AP.

In this situation, Sequence Number (SN) and Packet Number (PN) of the MPDUs transmitted from different APs to the same STA should be maintained to achieve seamless roaming. However, when the buffered MPDUs on the extender AP 110-2 come back through the backhaul, the fronthaul MPDUs should be changed to the backhaul MPDUs. In this case, the fronthaul MAC header corresponding to the MPDU should be converted to the backhaul MAC header and the SN and PN based on the original fronthaul MPDU are changed as well. If the MPDUs transmitted in the roaming process have fragment, it will cause the subsequent several MPDUs to be discarded during the replay check process on the receiving STA. The discarding of the fragmented MPDUs may cause a data lose issue.

Therefore, the embodiments of the present invention propose a solution of MPDU forwarding in a VBSS based mesh network. In this solution, when the extender AP receives an AMPDU transmitted from the root AP, the extender AP may de-aggregate the AMPDU into multiple MPDUs. The extender AP may obtain the corresponding address information of the multiple MPDUs and process the multiple MPDUs based on the corresponding address information. In this way, the converting the MAC header of MPDUs between backhaul and fronthaul and decryption and encryption of the data unit can be avoided, which improves the efficiency of data forwarding. Meanwhile, the interference between backhaul and fronthaul working on the same channel can be eliminated and the TP of whole link can be increased.

In general, a VBSS based mesh network may comprise a set of APs which can be set with same configuration, such as Service Set Identifier (SSID), Basic Service Set Identifier (BSSID) etc.

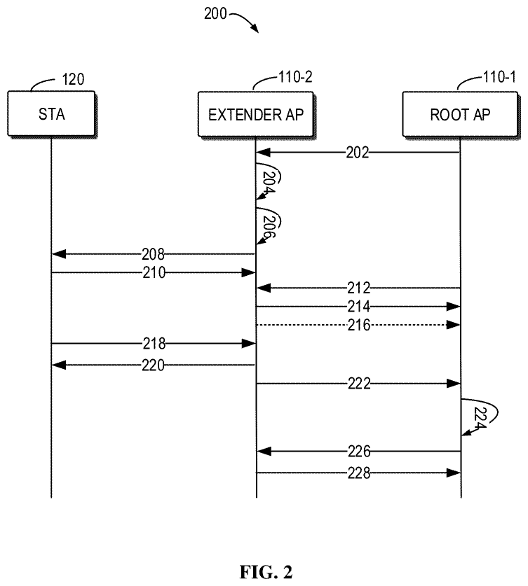

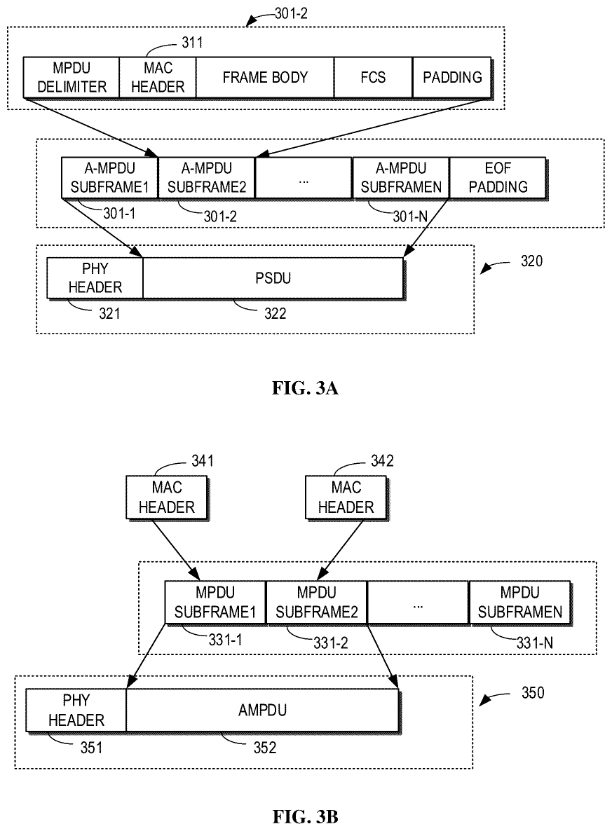

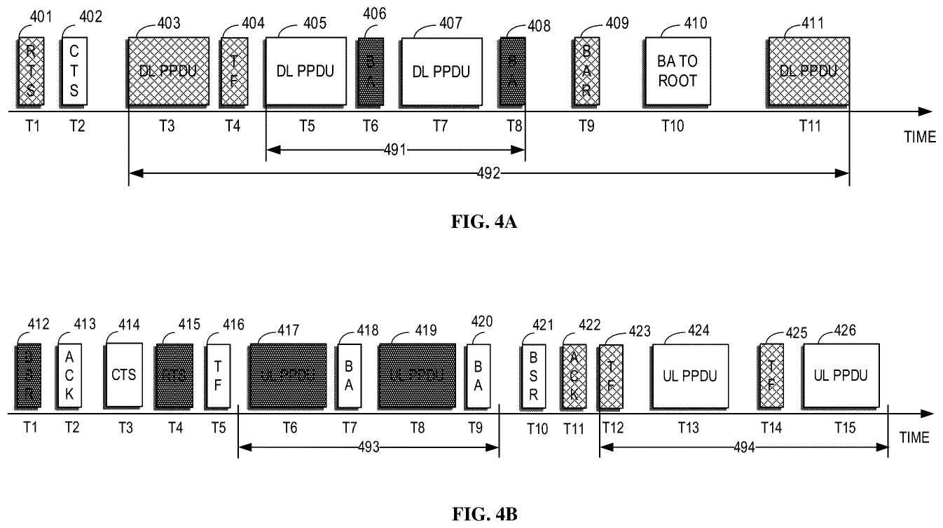

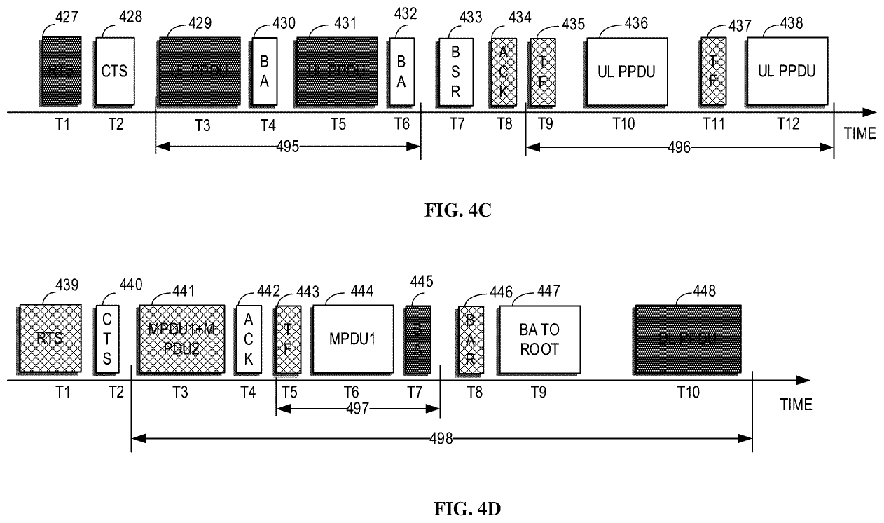

Principle and implementations of the present disclosure will be described in detail below with reference to FIG. 2, FIGS. 3A and 3B and FIGS. 4A-4D.

Reference is now made to FIG. 2. FIG. 2 illustrates demonstrating an example process 200 of MPDU forwarding in a VBSS based mesh network according to some embodiments of the present disclosure. For the purpose of this discussion, the process 200 will be described with reference to FIG. 1. The process 200 may involve the root AP 110-1, the extender AP 110-2 and the STA 120 as illustrated in FIG. 1.

The root AP 110-1 may aggregate multiple data frames into an aggregated data unit (hereinafter may be referred to as an aggregate MPDU (AMPDU)). The multiple data frames may include a set of data frames intend to transmit to the extender AP 110-2 and/or a further set of data frames intend to transmit to the STA 120. Each of the multiple data frame may have a MAC header comprises its transmitter address (TA) and receiver address (RA), which may indicate the transmitter address and the receiver address of this data frame respectively. A PHY header may be added to the AMPDU to indicate to which device (extender AP) should receive the AMPDU.

In some example embodiments, the STA_ID in the HE-SIG-B field or EHT-SIG User field of the PHY header can indicate which device should receive the AMPDU. The PHY header herein may be referred to PHY preamble and PHY header in 802.11 scope. If the AMPDU is to be received by the extender AP 110-2, the STA_ID can be the association identifier (AID) of the extender AP 110-2. The AID of each device in the VBSS network can be pre-configured/set.

For example, the AID of the AP 110-2 can be set to 1, the AID of the AP 110-3 (as shown in FIG. 1) can be set to 2 and the AID of the STA 130 can be set to 11. If the aggregated data unit is to be transmitted to the extender AP 110-2 from the Root AP 110-1, the STA_ID in the HE-SIG-B field or EHT-SIG User field of the PHY header should be 1.

After interacting with the extender AP 110-2, the root AP 110-1 may obtain a TXOP for the data transmission between the root AP 110-1 and the extender AP 110-2. As shown in FIG. 2, in the TXOP, the root AP 110-1 may transmit 202 the DL PPDU (including PHY header and AMPDU) to the extender AP 110-2. After receiving the PPDU, the extender AP 110-2 may determine whether the STA_ID in the PHY header of the PPDU matches its own AID. If the STA_ID in the PHY header of the PPDU matches its own AID, the extender AP 110-2 may de-aggregate 204 the AMPDU into multiple MPDUs. Then the extender AP 110-2 may check the TA and RA in each MPDU MAC header.

In some example embodiments, if the extender AP 110-2 determines that the MAC header of the multiple MPDUs have the VBSS fronthaul MAC address as TA and the MAC address of the STA 120 as RA, the extender AP 110-2 may determine that the MAC address of the STA 120 is the destination address of the multiple MPDUs. Then the extender AP 110-2 may re-aggregate 206 the multiple MPDUs into a new AMPDU and add a new PHY header for the new AMPDU for generating a new PPDU. Then the extender AP 110-2 may transmit 208 the new PPDU to the STA 120.

In some example embodiments, if the extender AP 110-2 determines that the MAC header of the multiple MPDUs have the backhaul MAC address of the root AP 110-1 as TA and the backhaul MAC address of the extender AP 110-2 as RA, the extender AP 110-2 may determine that the MAC address of the extender AP 110-2 is the destination address of the multiple MPDUs. Then the extender AP 110-2 may transmit 216 the ACK/BA to the root AP 110-1 to indicate that the multiple MPDUs have been received by the extender AP 110-2. Then the multiple MPDUs may be delivered to the high MAC layer of the extender AP 110-2 for further process.

In some example embodiments, if the extender AP 110-2 determines that the MAC header of a first portion of MPDUs in the multiple MPDUs have the VBSS fronthaul MAC address as TA and the MAC address of the STA 120 as RA and the MAC header of a second portion of MPDUs in the multiple MPDUs have the backhaul MAC address of the root AP 110-1 as TA and the backhaul MAC address of the extender AP 110-2 as RA, the extender AP 110-2 may generate a new PPDU by re-aggregating the first portion of MPDUs into a new AMPDU and adding a new PHY header for the new AMPDU and transmit the new PPDU to the STA 120. The extender AP 110-2 may also response an ACK/BA for the second portion of MPDUs to the root AP 110-1 and then delivery the second portion of MPDUs to the high MAC layer for the further process.

FIGS. 3A-3B shows examples of the data structure in the process of MPDU forwarding according to some embodiments of the present disclosure. With reference to FIGS. 3A-3B, the MPDU forwarding process of the present disclosure will be described in detail.

As shown in FIG. 3A, the PPDU 320 can be transmitted from the root AP 110-1 to the extender AP 110-2. The PPDU 320 may include a PHY header 321 and a PSDU 322. The PSDU herein can also be considered as an A-MPDU. The PHY header 321 may contain a HE-SIG-B field (refer to 11ax SPEC) or EHT-SIG User field (refer to 11be SPEC) having a STA_ID with 1. If the extender AP 110-2 determines that STA_ID=1 matches its AID, the extender AP 110-2 may divide the PSDU 322 of the PPDU 320 into multiple A-MPDU subframes 301-1 to 301-N. Then the extender AP 110-2 may check the RA and TA of each of the A-MPDU subframes 301-1 to 301-N. For example, the A-MPDU subframe2 301-2 may have a MAC header 311 in which the TA and RA of the A-MPDU subframe2 301-2 may be indicated. If the extender AP 110-2 determines, based on the address information of the A-MPDU subframes 301-1 to 301-N, that all A-MPDU subframes 301-1 to 301-N are to be transmitted to the STA 120, the extender AP 110-2 may re-aggregate the A-MPDU subframes 301-1 to 301-N into a new PSDU and generate a new PPDU based on the new PSDU. Then the new PPDU may be forwarded from the extender AP 110-2 to the STA 120. As another option, if the extender AP 110-2 determines, based on the address information of the A-MPDU subframes 301-1 to 301-N, that all A-MPDU subframes 301-1 to 301-N are to be transmitted to the extender AP 110-2, the extender AP 110-2 may send BA/ACK response to the root AP 110-1 to indicated that the A-MPDU subframes 301-1 to 301-N have been received by the extender AP 110-2.

It is also possible that the multiple de-aggregated MPDU subframes have different destination address. As shown in FIG. 3B, the PPDU 350 can be transmitted from the root AP 110-1 to the extender AP 110-2. The PPDU 350 may include a PHY header 351 and an AMPDU 352. The PHY header 351 may contain a HE-SIG-B field or EHT-SIG User field having a STA_ID with 1. If the extender AP 110-2 determines that STA_ID=1 matches its AID, the extender AP 110-2 may divides the AMPDU 352 of the PPDU 350 into multiple MPDU subframes 331-1 to 331-N. Then the extender AP 110-2 may check the RA and TA of each of the MPDU subframes 331-1 to 331-N. For example, if the extender AP 110-2 determines, based on the address information of the MPDU subframe1 331-1 indicated in the MAC header 341, that the MPDU subframe1 331-1 is to be transmitted to the STA 120 and determines, based on the address information of the MPDU subframe2 331-2 indicated in the MAC header 342, that the MPDU subframe2 331-2 is to be transmitted to the extender AP 110-2, the extender AP 110-2 may built a new PPDU based on the MPDU subframe1 331-1 and transmit the new PPDU to the STA 120. Meanwhile the extender AP 110-2 may also response a BA/ACK to the root AP 110-1 for the reception of the MPDU subframe2 331-2.

Now referring back to FIG. 2, in a case where the extender AP 110-2 determines that all MPDUs are to be transmitted to the STA 120, the STA 120 may transmit 210 a BA/ACK response to the extender AP 110-2 after the STA 120 receives the new PPDU.

Furthermore, the root AP 110-1 may require this BA/ACK transmitted from the STA 120 to the extender AP 110-2. The root AP 110-1 may transmit 212, to the extender AP 110-2, a request for the BA/ACK transmitted from the STA 120. Then the extender AP 110-2 may forward 214 the BA/ACK transmitted from the STA 120 to the root AP 110-1.

As mentioned above, a roaming event may occur at STA 120. For example, as shown in FIG. 1, the STA 120 may move from the coverage 102 of the extender AP 110-2 to the coverage 104 of the further extender AP 110-3. In this case, when the extender AP 110-2 detects the roaming of the STA 120, the extender AP 110-2 may report the roaming event of the STA 120 to the root AP 110-1.

In some example embodiments, the extender AP 110-2 may report a roaming request on the STA 120 with the BA/ACK received from the STA 120 to the root AP 110-1. For example, the extender AP 110-2 may generate an indication of the roaming event of the STA 120 and transmit this indication to the root AP 110-1 together with the root AP 110-1.

The MPDU forwarding for the DL communication has been described with the actions 202 to 216 as shown in FIG. 2. Hereafter the scenario of MPDU forwarding for the UL communication will be further explained.

Still referring to FIG. 2, when one or more MPDU(s) are expected to be transmitted from the STA 120 to the root AP 110-1, the STA 120 may transmit 218 one or more MPDU(s) to the extender AP 110-2. After receiving the MPDU(s), the extender AP 110-2 responses a BA/ACK to the STA 120 for indicating the reception of the MPDU(s).

Then the extender AP 110-2 may transmit 222 a Buffer Status Report (BSR) to the root AP 110-1. The BSR may indicate that one or more MPDU(s) are expected to be transmitted from the extender AP 110-2 received from STA 120 to the root AP 110-1. Meanwhile, the BSR may also comprise a bitmap of BA/ACK that has been transmitted to the STA 120 from the extender AP 110-2.

After receiving the BSR, the root AP 110-1 may determine 224 which MPDUs are expected to be received by the root AP 110-1 and transmit 226, to the extender AP 110-2, an indication of MPDUs that the root AP 110-1 expects to receive. The indication of MPDUs can be represented as a bitmap. After receiving the indication from the root AP 110-1, the extender AP 110-2 may transmit 228 the corresponding MPDUs to the root AP 110-1.

FIGS. 4A-4D show examples of time sequence for data transmission in the process of MPDU forwarding according to some embodiments of the present disclosure. The time sequence of different scenarios in the MPDU forwarding process will be further described as below.

FIG. 4A shows an example of time sequence for a DL transmission in the MPDU forwarding process according to some embodiments of the present disclosure. At T1 and T2, the root AP 110-1 obtains TXOP 492 after it interacts with the extender AP 110-2 through request-to-send (RTS)/clear-to-send (CTS) frame 401/402. At T3, the root AP 110-1 sends the DL PPDUs 403 to the extender AP 110-2. Then at T4, the root AP 110-1 sends a Trigger Frame 404 (TF) to the extender AP 110-2 containing a further TXOP duration 491 that the extender AP 110-2 can use.

At T5, the extender AP 110-2 can de-aggregate and re-aggregate the AMPDU received at T3 and sends the new PPDU 405 reassembled by the new AMPDU and a new PHY header to the STA 120. At T6, after receiving the PPDUs sent by the extender AP 110-2, the STA 120 may reply with BA/ACK 406. Then the extender AP 110-2 may release the acknowledged MPDUs. At T7, before TXOP 491 of the extender AP 110-2 expires, if there are still buffered data frames (MPDUs) 407 on the extender AP 110-2, these data frames will be sent to the STA 120 at this moment. At T8, after receiving the PPDUs sent by the extender AP 110-2, the STA 120 replies with BA/ACK 408.

At T9, the root AP 110-1 may send a BA Request 409 to the extender AP 110-2 that requires the extender AP 110-2 to report the BA sent by the STA 120. At T10, the extender AP 110-2 may send the received BA 410 to the root AP 110-1 and free all data frames buffered for the STA 120 at this moment. At T11, the root AP 110-1 may continue to send a further DL PPDU 411 (including new MPDUs and the MPDUs to be retransmitted) to the extender AP 110-2 before TXOP 492 expires.

For a case where the roaming process of the STA 120 occurs, at T6, the extender AP 110-2 may detect that the threshold of roaming is met based the measurement on the ACK/BA sent by STA 120. At T10, the extender AP 110-2 may issue a roaming request to the root AP 110-1 when sending the received BA 410 to the root AP 110-1. Before the TXOP 492 expires, the root AP 110-1 may select the new anchored AP for the STA 120 according to a certain algorithm, for example the extender AP 110-3. Then the root AP 110-1 may send DL PPDU (including new MPDUs and the MPDUs that need to be retransmitted) to the STA 120 through the extender AP 110-3.

FIG. 4B shows an example of time sequence for a UL transmission in the MPDU forwarding process according to some embodiments of the present disclosure.

At T1, the STA 120 may send a BSR 412 to the extender AP 110-2 to require sending UL PPDUs to the extender AP 110-2 with trigger-based manner. Then at T2, the extender AP 110-2 may reply with an ACK 413 to the STA 120 after receiving the BSR. At T3& T4, the extender AP 110-2 may obtain a TXOP 493 after it interacts with the STA 120 through RTS/CTS frame 414/415.

At T5, the extender AP 110-2 may send a trigger frame (TF) 416 to the STA 120 that contains the TXOP duration that the STA 120 can use. At T6, the STA 120 may send UL PPDUs 417 to the extender AP 110-2. At T7, the extender AP 110-2 may reply BA/ACK 418 after receiving UL PPDUs from the STA 120. After receiving BA/ACK, the STA 120 may release the acknowledged MPDUs. At T8, before the TXOP 493 of the STA 120 expires, the STA 120 may send the buffered data frames 419 to the extender AP 110-2 at this moment.

At T9, the extender AP 110-2 may reply with BA/ACK 420 after receiving the data frames from the STA 120. After receiving BA/ACK, the STA 120 may release the acknowledged MPDUs. At T10, the extender AP 110-2 may send a BSR 421 to the root AP 110-1 to require reporting the receipt of UL PPDUs from the STA 120 and the ACK/BA bitmap that has been sent to the STA 120. At T11, the root AP 110-1 sends an ACK 422 to the extender AP 110-2 to indicate the receipt of the BSR. At T12, the root AP 110-1 may send a TF 423 to the extender AP 110-2 containing a further TXOP 494 duration that the extender AP 110-2 can use for a data transmission between the extender AP 110-2 and the root AP 110-1 and a bitmap of UL MPDUs that it expects to receive.

At T13, the extender AP 110-2 may forward the UL MPDUs 424 received from the STA 120 to the root AP 110-1 according to the bitmap in the TF. At T14, the root AP 110-1 continues to send TF 425 to the extender AP 110-2 containing another TXOP duration belong to 494 that the extender AP 110-2 can use and the bitmap of UL PPDUs that it expects to receive before TXOP 494 expires. The TF 425 can be considered as a part of TF 423. At T15, the extender AP 110-2 may forward the UL MPDUs 426 received from the STA 120 to the root AP 110-1 according to the bitmap in the TF.

FIG. 4C shows a further example of time sequence for a UL transmission in the MPDU forwarding process according to some embodiments of the present disclosure.

At T1 and T2, the STA 120 may obtain TXOP 495 after it interacts with the extender AP 110-2 through RTS/CTS frame 427/428. At T3, the STA 120 may send UL PPDU 429 to the extender AP 110-2. At T4, the extender AP 110-2 may reply with BA/ACK 430 after receiving UL PPDUs from the STA 120. After receiving BA/ACK, the STA 120 may release the acknowledged MPDUs. At T5, before the TXOP 495 of the STA 120 expires, if there are still buffered data frames 431 on the STA 120, the STA 120 send them to the extender AP 110-2 at that time. At T6, the extender AP 110-2 may reply BA/ACK 432 after receiving UL PPDUs from the STA 120.

At T7, the extender AP 110-2 sends a BSR 433 to the root AP 110-1, to require reporting the receipt of UL PPDU from the STA 120 and the ACK/BA bitmap that has been sent to the STA 120. At T8, the root AP 110-1 may send an ACK 434 to the extender AP 110-2 to indicate the receipt of the BSR. At T9, the root AP 110-1 may send a TF 435 to the extender AP 110-2 containing a TXOP 496 duration that the extender AP 110-2 can use and the bitmap of UL MPDUs that it expects to receive.

At T10, the extender AP 110-2 forwards the UL MPDUs 436 received from the STA 120 to the root AP 110-1 according to the bitmap in the TF 435. At T11, the root AP 110-1 continues to send TF 437 to the extender AP 110-2 containing the TXOP belongs to 496 duration that the extender AP 110-2 can use and bitmap of UL PPDU that it expects to receive before TXOP 496 expires. At T12, the extender AP 110-2 forwards the UL MPDUs 438 received from the STA 120 to the root AP 110-1 according to the bitmap in the TF 437. The extender AP 110-2 may release all UL PPDUs after the TXOP 496 expires.

FIG. 4D shows a further of time sequence for a DL transmission in the MPDU forwarding process in which the root AP or the extender AP receives the backhaul and fronthaul hybrid AMPDUs according to some embodiments of the present disclosure.

At T1 and T2, the root AP 110-1 may obtain TXOP 498 after it interacts with the extender AP 110-2 through RTS/CTS frame 439/440. At T3, the root AP 110-1 may send the DL PPDU 441 to the extender AP 110-2. The DL PPDU 441 may contain MPDU1 (fronthaul MPDU) and MPDU2 (backhaul MPDU).

At T4, after the extender AP 110-2 receives the PPDU 441, the extender AP 110-2 may send an ACK 442 of MPDU2 to the root AP 110-1. Then the extender AP 110-2 may release the MPDU2 after receiving BA/ACK 442. At T5, the root AP 110-1 may send TF containing the TXOP 497 duration that the extender AP 110-2 can use. At T6, after receiving the PPDU 441 sent by the root AP 110-1, the extender AP 110-2 reassembles them into a new PPDU 444 after replacing with a new PHY header and sends to the STA 120. At T7, the STA 120 may reply with BA/ACK 445 after receiving PPDUs 444 from the extender AP 110-2.

At T8, the root AP 110-1 sends a BA Request 446 to the extender AP 110-2 that requires the extender AP 110-2 to report the BA sent by the STA 120. At T9, the extender AP 110-2 sends the received BA 447 to the root AP 110-1 via backhaul link and release MPDU1 after receiving the ACK sent by the root AP 110-1. At T10, the root AP 110-1 can continue to send DL PPDU 448 (including new MPDUs and MPDUs to be retransmitted) to the extender AP 110-2 before TXOP 498 expires.

In this way, the operation of converting the MAC header of MPDUs between backhaul and fronthaul and decryption and encryption of the data unit can be avoided, which improves the efficiency of data forwarding. Meanwhile, the interference between backhaul and fronthaul working on the same channel can be eliminated and the TP of whole link can be increased.

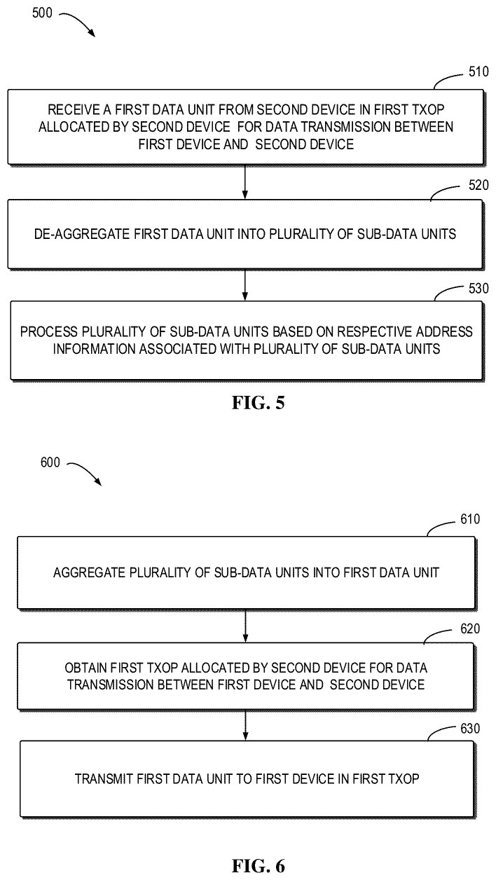

FIG. 5 shows a flowchart of an example method 500 of MPDU forwarding in a VBSS based mesh network according to some example embodiments of the present disclosure. The method 500 can be implemented at the first device 110-2 as shown in FIG. 1. For the purpose of discussion, the method 500 will be described with reference to FIG. 1.

At block 510, the first device receives a first data unit from a second device in a first TXOP allocated by the second device for data transmission between the first device and the second device, the first data unit has a header comprising an identifier of the first device.

At block 520, the first device de-aggregates the first data unit into a plurality of sub-data units.

At block 530, the first device processes the plurality of sub-data units based on respective address information associated with the plurality of sub-data units.

In some example embodiments, if the first device determines, based on the respective address information, that a set of sub-data units in the plurality of sub-data units are to be transmitted to a third device, the first device may re-aggregate the set of sub-data units into a second data unit and forward the second data unit to the third device in a second TXOP allocated by the second device for a data transmission between the first device and the third device.

In some example embodiments, if the first device determines that an acknowledgement indicating that the second data unit have been received by the third device is received, the first device may remove the set of sub-data units.

In some example embodiments, if the first device determines that the acknowledgement is required by the second device, the first device may forward the acknowledgement to the second device in the first TXOP.

In some example embodiments, if the first device determines that a roaming occurred at the third device based on the acknowledgement received from the third device, the first device may generate a roaming request to indicating a roaming event of the third device and transmit the roaming request together with the acknowledgement to the second device.

In some example embodiments, if the first device determines, based on the respective address information, that a further set of sub-data units in the plurality of sub-data units are to be transmitted to the first device, the first device may transmit, to the second device in the first TXOP, an acknowledgement indicating that the further set of sub-data units have been received by the first device.

In some example embodiments, if the first device determines that a third data unit received from the third device is to be transmitted to the second device, the first device may transmit, to the second device in a third TXOP allocated by the second for further data transmission between the first device and the second device, a buffer status report indicating the third data unit is to be transmitted from the third device to the second device and an acknowledgement associated with third data unit transmitted from the first device to the third device. If the first device determines that the third data unit is expected to be received by the second device based on a trigger received from the second device, the first device may forward the third data unit to the second device in the third TXOP.

FIG. 6 shows a flowchart of an example method 600 of MPDU forwarding in a VBSS based mesh network according to some example embodiments of the present disclosure. The method 600 can be implemented at the second device 110-1 as shown in FIG. 1. For the purpose of discussion, the method 600 will be described with reference to FIG. 1.

At 610, the second device aggregates a plurality of sub-data units into a first data unit, the first data unit having a header comprising an identifier of a first device.

At 620, the second device obtains a first transmission opportunity, TXOP, allocated for data transmission between the first device and the second device.

At 630, the second device transmits the first data unit to the first device in the first TXOP.

In some example embodiments, if the plurality of sub-data units comprises a set of sub-data units to be transmitted to a third device, the second device may transmit, to the first device in the first TXOP, a request for an acknowledgement indicating that the set of sub-data units have been received by the third device.

In some example embodiments, if the plurality of sub-data units comprises a further set of sub-data units to be transmitted to a first device, the second device may receive, from the first device in the first TXOP, an acknowledgement indicating that the further set of sub-data units have been received by the first device.

In some example embodiments, if the second device determines that a roaming request indicating a roaming event of the third device is received together with the acknowledgement for set of sub-data units, the second device may assign a fourth device to the third device for a subsequent data transmission from the second device to the third device.

In some example embodiment, if the second device determines that a buffer status report is received from the first device in a third TXOP allocated by the second for further data transmission between the first device and the second device, the buffer status report indicating the third data unit is to be transmitted from a third device to the second device and an acknowledgement associated with third data unit transmitted from the first device to the third device, the second device may determine whether the third data unit is expected to be received by the second device. If the second device determines that the third data unit is expected to be received, the second device may generate a trigger for the first device to forward the third data unit to the second device and transmit the trigger to the first device in the third TXOP.

In some example embodiments, an apparatus capable of performing the method 500 (for example, implemented at the first device 110-2) may comprise means for performing the respective steps of the method 500. The means may be implemented in any suitable form. For example, the means may be implemented in a circuitry or software module.

In some example embodiments, the apparatus comprises means for receiving, at a first device, a first data unit from a second device in a first TXOP allocated by the second device for data transmission between the first device and the second device, the first data unit having a header comprising an identifier of the first device; means for de-aggregating the first data unit into a plurality of sub-data units; and means for processing the plurality of sub-data units based on respective address information associated with the plurality of sub-data units.

In some example embodiments, an apparatus capable of performing the method 600 (for example, implemented at the second device 110-1) may comprise means for performing the respective steps of the method 600. The means may be implemented in any suitable form. For example, the means may be implemented in a circuitry or software module.

In some example embodiments, the apparatus comprises means for aggregating, at a second device, a plurality of sub-data units into a first data unit, the first data unit having a header comprising an identifier of a first device; means for obtaining a first TXOP allocated by the second device for data transmission between a first device and the second device; and means for transmitting the first data unit to the first device in the first TXOP.

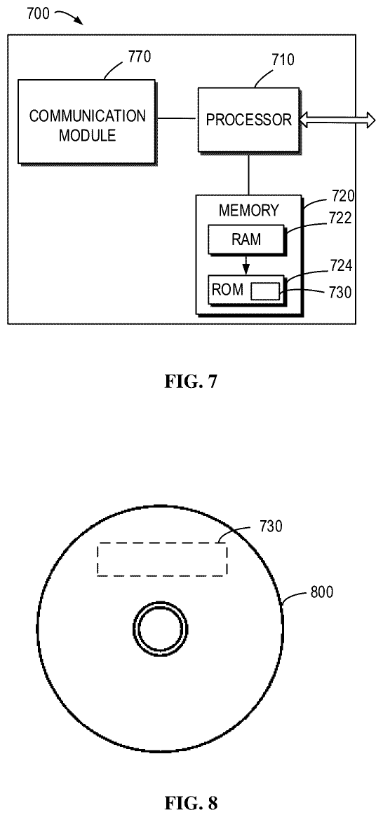

FIG. 7 is a simplified block diagram of a device 700 that is suitable for implementing embodiments of the present disclosure. The device 700 may be provided to implement the communication device, for example the extender AP 110-2 and the root AP 110-1 as shown in FIG. 1. As shown, the device 700 includes one or more processors 710, one or more memories 740 coupled to the processor 710, and one or more transmitters and/or receivers (TX/RX) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 720. The processor 710 may perform any suitable actions and processing by loading the program 730 into the RAM 720.

The embodiments of the present disclosure may be implemented by means of the program 730 so that the device 700 may perform any process of the disclosure as discussed with reference to FIGS. 2 to 4D. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8. shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 500 and 600 as described above with reference to FIGS. 5-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory including computer program codes;
the at least one memory and the computer program codes are configured to, with the at least one processor, cause the first device at least to:
receive a first data unit from a second device in a first transmission opportunity, TXOP, allocated by the second device for data transmission between the first device and the second device, the first data unit having a header comprising an identifier of the first device;
de-aggregate the first data unit into a plurality of sub-data units; and
process the plurality of sub-data units based on respective address information associated with the plurality of sub-data units.

2. The first device of claim 1, wherein the first device is caused to process the plurality of sub-data units by:
in accordance with a determination, based on the respective address information, that a set of sub-data units in the plurality of sub-data units are to be transmitted to a third device, re-aggregating the set of sub-data units into a second data unit; and
forwarding the second data unit to the third device in a second TXOP allocated by the second device for a data transmission between the first device and the third device.

3. The first device of claim 2, wherein the first device is further caused to:
in accordance with a determination that an acknowledgement is received, the acknowledgement indicating the second data unit has been received by the third device, remove the set of sub-data units.

4. The first device of claim 3, wherein the first device is further caused to:
in accordance with a determination that the acknowledgement is required by the second device, forward the acknowledgement to the second device in the first TXOP.

5. The first device of claim 4, wherein the first device is further caused to:
in accordance with a determination that a roaming occurred at the third device based on the acknowledgement received from the third device, generate a roaming request to indicating a roaming event of the third device; and
transmit the roaming request together with the acknowledgement to the second device.

6. The first device of claim 1, wherein the first device is further caused to:
in accordance with a determination, based on the respective address information, that a further set of sub-data units in the plurality of sub-data units are to be transmitted to the first device, transmit, to the second device in the first TXOP, an acknowledgement indicating that the further set of sub-data units have been received by the first device.

7. The first device of claim 1, wherein the first device is further caused to:
in accordance with a determination that a third data unit received from the third device is to be transmitted to the second device, transmit, to the second device in a third TXOP allocated by the second device for further data transmission between the first device and the second device, a buffer status report indicating the third data unit is to be transmitted from the third device to the second device and an acknowledgement associated with third data unit transmitted from the first device to the third device; and
in accordance with a determination that the third data unit is expected to be received by the second device based on a trigger received from the second device, forward the third data unit to the second device in the third TXOP.

8. The first device of claim 1, wherein the first device comprises an extender access point or an agent access point and the second device comprises a root access point or a gateway.

9. A second device comprising:
at least one processor; and
at least one memory including computer program codes;
the at least one memory and the computer program codes are configured to, with the at least one processor, cause the second device at least to:
aggregate a plurality of sub-data units into a first data unit, the first data unit having a header comprising an identifier of a first device;
obtain a first transmission opportunity, TXOP, allocated by the second device for data transmission between the first device and the second device; and
transmit the first data unit to the first device in the first TXOP.

10. The second device of claim 9, wherein the plurality of sub-data units comprises a set of sub-data units to be transmitted to a third device, wherein the second device is further caused to:
transmit, to the first device in the first TXOP, a request for an acknowledgement indicating that the set of sub-data units have been received by the third device.

11. The second device of claim 9, wherein the plurality of sub-data units comprises a further set of sub-data units to be transmitted to a first device, wherein the second device is further caused to:
receive, from the first device in the first TXOP, an acknowledgement indicating that the further set of sub-data units have been received by the first device.

12. The second device of claim 10, wherein the second device is further caused to:
in accordance with a determination that a roaming request indicating a roaming event of the third device is received together with the acknowledgement for set of sub-data units, assign a fourth device to the third device for a subsequent data transmission from the second device to the third device.

13. The second device of claim 9, wherein the second device is further caused to:
in accordance with a determination that a buffer status report is received from the first device in a third TXOP allocated by the second device for further data transmission between the first device and the second device, the buffer status report indicating the third data unit is to be transmitted from a third device to the second device and an acknowledgement associated with third data unit transmitted from the first device to the third device, determine whether the third data unit is expected to be received by the second device; and
in accordance with a determination that the third data unit is expected to be received, generate a trigger for the first device to forward the third data unit to the second device; and
transmit the trigger to the first device in the third TXOP.

14. The second device of claim 9, wherein the first device comprises an extender access point or an agent access point and the second device comprises a root access point or a gateway.

15. A method comprising:
receiving, at a first device, a first data unit from a second device in a first transmission opportunity, TXOP, allocated by the second device for data transmission between the first device and the second device, the first data unit having a header comprising an identifier of the first device;
de-aggregating the first data unit into a plurality of sub-data units; and
processing the plurality of sub-data units based on respective address information associated with the plurality of sub-data units.

16. A method comprising:
aggregating, at a second device, a plurality of sub-data units into a first data unit, the first data unit having a header comprising an identifier of a first device;
obtaining a first transmission opportunity, TXOP, allocated by the second device for data transmission between a first device and the second device; and
transmitting the first data unit to the first device in the first TXOP.

17. (canceled)

18. (canceled)

19. (canceled)

20. (canceled)
